(19) United States
(12) Patent Application Publication
(10) Pub. No.: US 2014/0351433 A1
(43) Pub. Date: Nov. 27, 2014

(54) NETWORK DEVICE AND OPERATING METHOD THEREOF

(71) Applicant: Accton Technology Corporation, Hsinchu (TW)

(72) Inventor: Chien-Fu SUNG, New Taipei City (TW)

(73) Assignee: ACCTON TECHNOLOGY CORPORATION, Hsinchu (TW)

(21) Appl. No.: 14/089,774

(22) Filed: Nov. 26, 2013

(30) Foreign Application Priority Data
May 27, 2013 (TW) 102118665

(51) Int. Cl. H04L 29/08

(52) U.S. Cl. CPC H04L 67/14
USPC 709/225

(57) ABSTRACT

A network device and an operating method thereof are disclosed, where the network device includes a setting unit and a connection unit coupled with the setting unit. The setting unit sets a first port as a predetermined port for a communication protocol, and the connection unit allows a client device to use the communication protocol to connect to the first port. When a client device sends a port-change request, the setting unit changes the predetermined port to a second port according to the port-change request. The connection unit maintains a communication between the first port and the client device and further allows another client device to use the communication protocol to connect to the second port.

### RELATED APPLICATIONS

This application claims priority to Taiwan Patent Application No. 102118665, filed May 27, 2013, the entirety of which is herein incorporated by reference.

### BACKGROUND

1. Technical Field

The present disclosure relates to an electronic device; more particularly, a network device and an operating method thereof.

2. Description of Related Art

Currently, network devices set or change the service ports by following two schemes.

The first scheme, to facilitate the setting, saves only configuration profile that will not take effect until the system is shut down and restarted (or rebooted). However, under this scheme, if the new setting is inconsistent with the actual setting, it is unable instantly to validate the effect of the new setting, and hence, the errors associated therewith cannot be found promptly. For example, assuming that the service port of the original hyper-text transfer protocol (HTTP) is 80, when administrator resets it to 5246, it would conflict with the CAPWAP control port; however, since it is impossible to be instantly validated for said control port is not a commonly-used port, and the administrator could not find out this conflict. When the HTTP service is restarted later, the service will fail and it is impossible to reset via the webpage; further, when the new setting takes effect after the restart, it will interrupt the original administration session. For example, assuming that the network device allows four connections at the same time, either from different administrators or a single administrator, if one administrator has to reset the service only due to the change of the port, and, at the same time, other administrators maybe set a new wireless internet service such as: name, safety level, encryption method, VLAN, band broad limitation, etc., these settings in action will be interrupted by the restart of said one administrator, thereby resulting in an incomplete setting that requires to be reset, which is troublesome to other administrators.

In the second scheme, to allow the new settings to take effect instantly, the existing administration session(s) has to terminate right away. Nonetheless, this scheme would affect other settings such as interactive/batch settings. For example, during the setting of a new enterprise access point, it is often required to set the administration page of the access point (HTTP) and the telnet/SSH port, the access control limitation, SSID name, safety level, encryption method, VLAN, band broad limitation, etc. To simplify the burden of the administrator and avoid the input error, these settings are often set in batch using batch files by the input-orientation method. However, no matter that the setting is performed by batch input or using manually-inputted commands, if system restarts right away for the in port setting is changed, the subsequent commands could not be executed properly. As a result, the administrator, when drafting the batch file, must pay attention to the presence of the instance of the change in port setting, and he or she also have to change the port setting from the one-time setting to the split settings; moreover, the setting may be interrupted by the restart and cannot be completed. For example, for a web page, the setting of HTTP port is often presented in the same page with other settings (such as, SSH, Telnet). If the setting of the HTTP port takes effect instantly or restart at once, the changes in the same webpage cannot be carried out successfully.

In view of the foregoing, there exist problems and disadvantages in the related art that await further improvement, but those skilled in the art sought vainly for a solution. In order to solve or circumvent above problems and disadvantages, there is an urgent need in the related field to change the port more effectively.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides a network device and an operating method thereof to overcome the problems which has faced the prior art.

According to one embodiment of the present disclosure, a network device comprises a setting unit and a connection unit which is coupled with the setting unit. The setting unit set a first port as a default port of a communication protocol, and the connection unit allows a client device to connect with the first port according to the communication protocol; when the client device sends a port-change request, the setting unit sets a second port as the default port of the communication protocol according to the port-change request, and the connection unit maintains a communication between the first port and the client device, and allows another client device to connect to the second port according to the communication protocol.

In one embodiment, the connection unit sets the second port as the default port, and further denies another client device from connecting to the first port according to the communication protocol.

In one embodiment, the setting unit setting unit respectively sets a flag of the first port and the second port according to the port-change request; commands the connection unit, based on the flag of the first port, to deny another client device from connecting to the first port according to the communication protocol; and commands the connection unit, based on the flag of the second port, to allow another client device to connect to the second port according to the communication protocol.

In one embodiment, the connection unit further determines that whether the client device transmits data via the first port, and when the client device transmits data via the first port, the connection unit maintains the communication between the first port and the client device.

In one embodiment, the network device may also further comprise a timing unit. The timing unit calculates that whether a duration for which the client device stops transporting data via the first port exceeds a predetermined time, and when the duration exceeds the predetermined time, the connection unit interrupts the communication between the first port and the client device.

According to another aspect of the present disclosure, in the operating method of the network device, the network device has at least a first port and a second port, and the operating method comprises the following steps: (a) setting the first port as a default port of a communication protocol, and allowing a client device to connect to the first port according to the communication protocol; (b) when the client device sends a port-change request via the first port, setting the second port as the default port of the communication protocol according to the port-change request; and (c) maintaining the communication between the first port and the client device, and allowing another client device to connect to the second port according to the communication protocol.

In one embodiment, the operating method further comprises, after setting the second port as the default port of the communication protocol, denying another client device from connecting to the first port according to the communication protocol.

In one embodiment, the step (b) comprises, after receiving the port-change request, setting a flag of the first port as a first status, and setting a flag of the second port as a second status; and the step (c) comprises, when the flag of the first port is the first status, denying another client device from connecting to the first port according to the communication protocol, and when the flag of the second port is the second status, allowing another client device to connect to the second port according to the communication protocol.

In one embodiment, the operating method further comprises, determining whether the client device transmits data via the first port, and when the client device transmits data via the first port, maintaining the communication between the first port and the client device.

In one embodiment, the operating method further comprises, calculating that whether a duration for which the client device stops transmitting data via the first port exceeds a predetermined time; and when the duration exceeds the predetermined time, interrupting the communication between the first port and the client device.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

1. There is no need to shut down the network device and then restart it, and the change to the port would take effect immediately; hence, the setting and the service are in accordance, and it allows the administrator to validate the validity of the service of the new port (i.e., the second port) instantly, so that the management and setting could be done at one time rather than finishing it by several connections of several times; and

2. All administration sessions connecting to the prior or original port (i.e., the first port) of the network device are maintained continuously to carry out the functions of management and setting, and hence, this solution supports the batch-type (profile) remote automatic setting, which ensures the correct execution of subsequent provision(s) after the port change without interruption or disconnection.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram illustrating a network device according to one embodiment of the present disclosure; and

FIG. 2 is a flow diagram illustrating an operating method of a network device according to one embodiment of the present disclosure.

### DETAILED DESCRIPTION

In the following detailed description, for purposes of explanation, numerous specific details are set forth in order to attain a thorough understanding of the disclosed embodiments. In accordance with common practice, the various described features/elements are not drawn to scale but instead are drawn to best illustrate specific features/elements relevant to the present invention. Also, like reference numerals and designations in the various drawings are used to indicate like elements/parts. Moreover, well-known structures and devices are schematically shown in order to simplify the drawing and to avoid unnecessary limitation to the claimed invention.

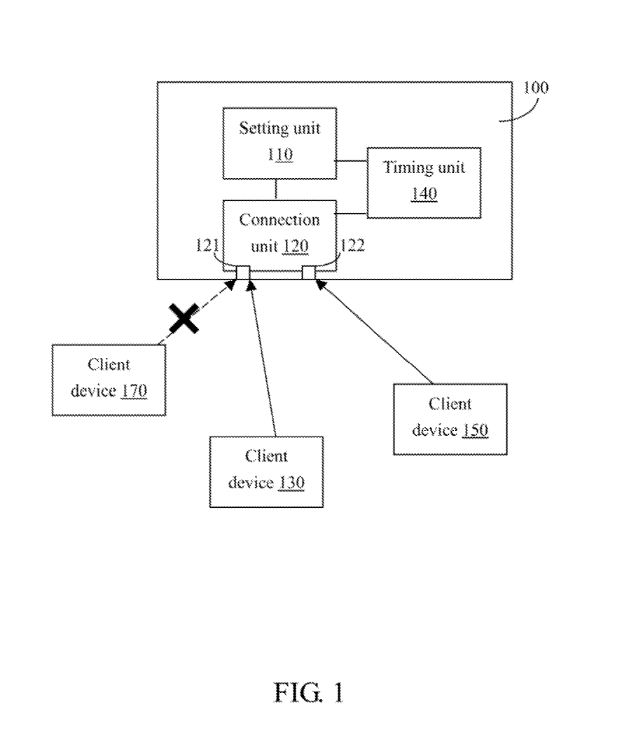

FIG. 1 is a block diagram illustrating a network device 100 according to one embodiment of the present disclosure. As illustrated in FIG. 1, the network device 100 comprises a setting unit 110 and a connection unit 120. In practice, the network device 100 may be a base station or other electric devices or communication devices capable of connecting to the internet; however, the present invention is not limited thereto. Structurally, the connection unit 120 is coupled with the setting unit 110. In operation, the setting unit 110 sets a first port 121 as a default port of a communication protocol, and the connection unit 120 allows the client device 130 to connect to the first port 121 according to the communication protocol; when the client device 130 sends a port-change request to the network device 100 via the first port 121, the setting unit 110 change a second port 122 as the default port of the communication protocol according to the port-change request, but after the default port is changed from the first port 121 to the second port 122, the connection unit 120 still maintains the communication between the first port 121 and the client device 130, and allows another client device 150 to connect with the second port according to the communication protocol.

Based on the above-discussed infrastructure, there is no need to shut down the network device 100 and then restart it, and the change to the default port corresponding to the communication protocol would take effect immediately; hence, the setting and the service are in accordance, and it allows the administrator to validate the validity of the service of the new port (i.e., the second port 122) instantly, so that the management and setting could be done at one time rather than finishing it by several connections in several times; further, all administration sessions connecting to the prior or original port (i.e., the first port 121) of the network device 100 are maintained continuously to carry out the functions of management and setting, and hence, this solution not only supports the batch-type remote automatic setting, which allows the correct execution of subsequent provision(s) after the port change without interruption or disconnection, the connection unit 120 also can support the interactive administrator remote control.

After the default port is changed from the first port 121 to the second port 122, the connection unit 120 denies another client device 170 from connecting to the first port 121 according to the communication protocol; that is, the connection unit 120 denies another client device 170 from connecting to the network device 100 via the first port 121 according to said communication protocol; in this way, the setting and service are in accordance, thereby avoiding issues associated with information safety. In practice, the communication protocol can be the hyper-text transfer protocol (HTTP), Telnet protocol, or other Internet protocols; however, the present invention is not limited thereto.

In one embodiment, the present invention further utilizes the technique of flag setting to realize the concrete control of the communication between the network device and the client device, the flag of the port represents the status of the port; in practice, it is often achieved by a register or a pin, in which the bit value of the register or the level status of the pin is used to determine and control the status of the port; the setting unit 110, after receiving a port-change request, respectively sets the flag of the first port 121 and the second port 122 according to the port-change request. Specifically, the setting unit 110 sets the flag of the first port 121 as a first status (for example, changing the bit value of the flag from 0 to 1, or from a low level status to a high level status); and sets the flag of the second port 122 as a second status (for example, setting the bit value of the flag as 0 or a low level status), such that when the bit value as the flag of the first port is 1, the connection unit 120, based on the flag of the first port 121, denies another client device 170 from connecting to the first port 121 according to the communication protocol; that is, the connection unit 120 denies another client device 170 from connecting to the network device 100 via the first port 121 under the communication protocol; and when the bit value as the flag of the second port 122 is 0, the connection unit 120, based on the flag of the second port 122, allows another client device 170 to connect to the second port 122 according to the communication protocol; that is, the connection unit 120 allows the client device 150 to connect to the network device 100 via the second port 122 under the communication protocol. In this way, the network device 100 uses the common flag and signals from the system to notify all existing prior port (i.e., the first port 121) to deny new connection request (due to the change of the port), but it will not actively terminate the current administration session (connection) of the existing client device 130. It shall be noted that, the setting content of the status of the flag according to the present invention is not limited to those discussed above; for example, in other embodiments, the bit value of the first status can be 0 (i.e., a low level status), whereas the it value of the second status is 1 (i.e., the high level status).

Next, the present invention waits for the administrator to actively terminate the original administration session (connection) of the existing client device 130. If all the sessions (such as connections) of the prior port or original port (i.e., the first port 121) are terminated, the connection unit 120 then automatically terminates the connection service corresponding to the prior port.

Alternatively, the network device 100 may automatically terminate the current connection with the prior port or original port whenever appropriate. In one embodiment, after the default port is changed from the first port 121 to the second port 122, the connection unit 120 maintains the communication between the first port 121 and the original client device 130, and the connection unit 130 further determines that whether the client device 130 transmits data via the first port 121; when the client device 130 transmits data via the first port 121, the connection unit 130 maintains the communication between the first port 121 and the client device 130 continuously. In contrast, when the client device 130 stops transmitting data via the first port 121, the timing unit 140 of the network device 100 is configured to count whether a duration for which the client device 130 ends transmitting data via the first port 121 exceeds a predetermined time, and when the duration exceeds the predetermined time, the connection unit 130 breaks off the communication between the first port 121 and the client device 130, thereby avoiding issues associated with information safety. In practice, said predetermined time could be flexibly selected by the programmer depending on the actual application. For example, the predetermined time can be about 120 seconds.

The above-mentioned setting unit 110, connection unit 120 and timing unit 140 may be implemented as the hardware, software, and/or firmware. For example, if speed and accuracy of execution are primary requirement, the implementer may adopt a mainly hardware and/or firmware implementation, (such as a chip set commonly used in a network device to process the package, and a micro controller for controlling each port); alternatively, if flexibility is first, the implementer may opt for a mainly software implementation in conjunction with an associated processor to execute said software, and the timing function can be implemented by a counter or timer interrupt within the processor or the controller, or by an independent, external oscillator; or, yet again alternatively, the implementer may opt for some combination of hardware, software, and/or firmware. It should be noted that, none of the above-mentioned examples is inherently superior to the other and shall be considered limiting to the scope of the in present invention; rather, these examples can be utilized depending upon the context in which the unit/component will be deployed and the specific concerns (e.g., speed, flexibility, or predictability) of the implementer, any of which may vary.

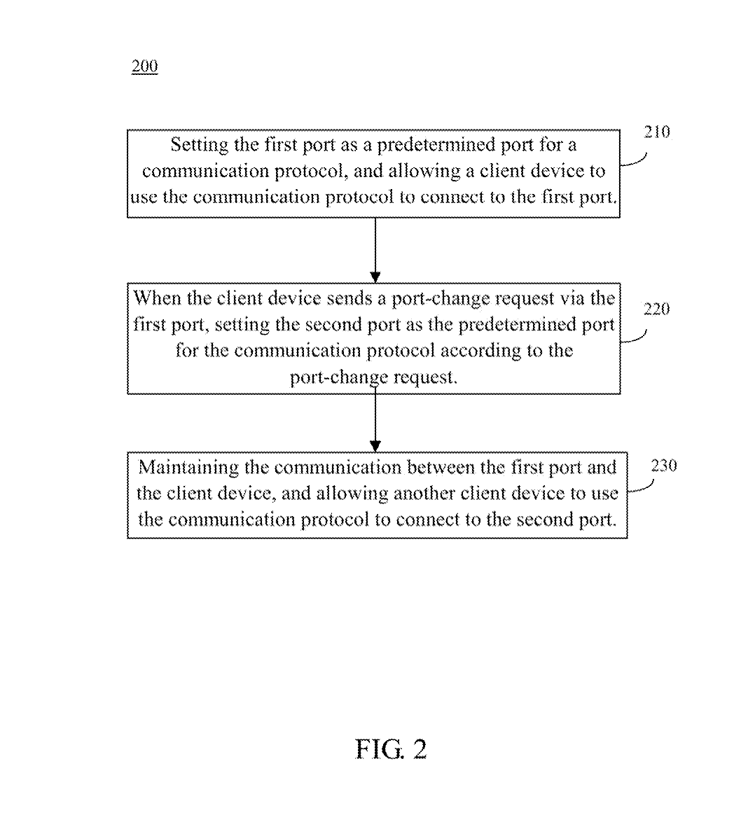

FIG. 2 is a flow diagram illustrating an operating method 200 of a network device according to one embodiment of the present invention; in this embodiment, the network device has at least a first port and a second port. As illustrated in FIG. 2, the operating method 200 includes steps 210 to 230. It should be appreciated that the steps are not recited in the sequence in which the steps are performed. That is, unless the sequence of the steps is expressly indicated, the sequence of the steps is interchangeable, and all or part of the steps may be simultaneously, partially simultaneously, or sequentially performed. Also, the hardware devices for implementing these steps have been specifically disclosed in the above embodiments, and hence, detailed description thereof is omitted herein for the sake of brevity.

In step 210, the first port is set as a default port of a communication protocol, and a client device is allowed to connect to the first port according to the communication protocol; that is, the client device may communicate with the network device via the first port according to the communication protocol. In step 220, when the client device sends a port-change request to the network device via the first port, the second port is set as the default port of the communication protocol according to the port-change request. In step 230, after the default port is changed from the first port to the second port, the original communication between the first port and the client device is maintained, and another client device is allowed to connect to the second port under the communication protocol; that is, another client device is allowed to communicate with the network device via the second port according to the communication protocol. In this way, there is no need to shut down the network device and then restart it, and the change to the port would take effect immediately; hence, the setting and the service are in accordance, and it allows the administrator to validate the validity of the service of the new port (i.e., the second port) instantly, so that the management and setting could be accomplished at one time rather than finishing it by several connections of several times; further, all administration sessions connecting to the prior port (i.e., the first port) of the network device are maintained continuously to carry out the functions of management and setting, and hence, this solution not only supports the batch-type (profile) remote automatic setting, which allows the correct execution of subsequent provision(s) after the port change without interruption or disconnection, it also support the interactive administrator remote control.

The operating method 200 further comprises, after changing the default port of the communication protocol from the first port to the second port, denying another client device from connecting to the first port under the communication protocol; that is, the another client device cannot communicate with the network device via the first port according to the communication protocol, thereby preventing issues associated with information safety.

Step 220 comprises, after receiving the port-change request, setting a flag of the first port as a first status, and setting a flag of the second port as a second status; and step 230 comprises, when the flag of the first port is the first status, denying another client device from connecting to the first port according to the communication protocol (that is, the another client device cannot communicate with the network device via the first port under the communication protocol), and when the flag of the second port is the second status, allowing another client device to connect with the second port according to the communication protocol (that is, the client device can communicate with the network device via the second port under the communication protocol. In this way, the operating method 200 utilizes the common flag and signals from the system to notify all existing prior port (i.e. the first port) to deny new connection request (due to the default port is changed), but it will not actively terminate the original administration session (connection) of the current client device. The detailed techniques of the flag setting of the port have been discussed above, and hence, detailed description thereof is omitted herein for the sake of brevity.

Next, the present method waits for the administrator to actively terminate the original administration session (connection). If all the connections of the prior port (i.e., the first port, the original default port) are terminated, the operating method 200 then automatically terminates the connection service corresponding to the pr or port.

Alternatively, the operating method 200 may automatically terminate the connection with the prior port whenever appropriate. In one embodiment, the operating method 200 further comprises, after maintaining the communication between the first port and the client device, determining whether the client device continues to transmits data via the first port, such that when the client device transmits data via first port, the present method maintains the communication between the first port and the client device; in contrast, when the client device stops transmitting data via the first port, counting whether a duration for which the client device stops transmitting data via the first port exceeds a predetermined time, and when the duration exceeds the predetermined time, the present method breaks off the communication between the first port and the original client device, thereby avoiding issues associated with information safety. In practice, said predetermined time could be flexibly selected by the programmer depending on the actual application.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A network device, comprising,
a setting unit, configured to set a first port as a default port of a communication protocol; and
a connection unit, coupled with the setting unit and configured to allow a client device to connect with the first port according to the communication protocol, wherein, when the client device sends a port-change request, the setting unit sets a second port as the default port of the communication protocol according to the port-change request, and the connection unit maintains a communication between the first port and the client device and allows another client device to connect with the second port according to the communication protocol.

2. The network device according to the claim 1, wherein the connection unit sets the second port as the default port, and denies another client device from connecting to the first port according to the communication protocol.

3. The network device according to the claim 1, wherein the setting unit respectively sets a flag of the first port and the second port according to the port-change request, the connection unit, based on the flag of the first port, denies another client device from connecting to the first port, and allows another client device to connect with the second port according to the communication protocol.

4. The network device according to the claim 1, wherein the connection unit further determines that whether the client device transmits data via the first port, and when the client device transmits data via the first port, the connection unit maintains the communication between the first port and the client device.

5. The network device according to the claim 4, further comprising,
a timing unit, configured to calculate that whether a duration for which the client device stops transmitting data via the first port exceeds a predetermined time, and when the duration exceeds the predetermined time, the connection unit interrupts the communication between the first port and the client device.

6. An operating method of a network device, the network device comprising at least a first port and a second port, the operating method comprising:
(a) setting the first port as a default port of a communication protocol, and allowing a client device to connect with the first port according to the communication protocol;
(b) when the client device sends a port-change request via the first port, setting the second port as the default port of the communication protocol according to the port-change request; and
(c) maintaining the communication between the first port and the client device, and allowing another client device to connect with the second port according to the communication protocol.

7. The operating method according to the claim 6, further comprising:
after setting the second port as the default port of the communication protocol, denying another client device from connecting to the first port according to the communication protocol.

8. The operating method according to the claim 6, wherein the step (b) comprises: after receiving the port-change request, setting a flag of the first port as a first status, and setting a flag of the second port as a second status;
the step (c) comprises: when the flag of the first port is the first status, denying another client device from connecting to the first port according to the communication protocol, and when the flag of the second port is the second status, allowing another client device to connect to the second port according to the communication protocol.

9. The operating method according to the claim 6, further comprising:
determining whether the client device transmits data via the first port, and when the client device transmits data via the first port, maintaining the communication between the first port and the client device.

10. The operating method according to the claim 9, further comprising:
calculating that whether a duration for which the client device stops transmitting data via the first port exceeds a predetermined time; and
when the duration exceeds the predetermined time, interrupting the communication between the first port and the client device.
